(19) United States
(12) Patent Application Publication
(10) Pub. No.: US 2014/0338999 A1
(43) Pub. Date: Nov. 20, 2014

(54) STRUCTURE FOR MOUNTING BATTERY PACK ON VEHICLE

(71) Applicant: HONDA MOTOR CO., LTD., Tokyo (JP)

(72) Inventors: Ryo Fujii, Wako-shi (JP); Yasuaki Hotozuka, Wako-shi (JP); Koichi Yamamoto, Wako-shi (JP)

(73) Assignee: HONDA MOTOR CO., LTD., Tokyo (JP)

(21) Appl. No.: 14/362,469

(22) PCT Filed: Dec. 5, 2012
(86) PCT No.: PCT/JP2012/081505

§ 371 Date: Jun. 3, 2014

(30) Foreign Application Priority Data
Dec. 9, 2011 (JP) 2011-269841

(51) Int. Cl. B60L 11/18; H01M 2/10; H01M 10/6561; H01M 10/625; B60K 1/04; B60K 11/06

(52) U.S. Cl. CPC B60L 11/1874; B60K 1/04; B60K 11/06; B60L 11/1877; H01M 10/5063; H01M 10/5016; H01M 2/1083; B60K 2001/0422; H01M 2220/20
USPC 180/68.5; 429/83

(57) ABSTRACT

In a structure for mounting a battery pack on a vehicle, since a recess portion, into which a cross member is fitted, is formed on an upper face of a battery case so as to extend in a vehicle width direction, it is possible to mount the battery pack on a vehicle body without interfering with the cross member, and it is unnecessary to raise the position of the cross member or form a cutout in the cross member, thereby enabling a balance to be achieved between the capacity of a vehicle compartment and the strength of the cross member while ensuring a sufficient minimum ground clearance for the battery pack and preventing a battery from becoming wet. Furthermore, since the recess portion is formed on the upper face of the battery case, a cooling passage disposed beneath the battery is not narrowed, thus ensuring the battery cooling performance.

### TECHNICAL FIELD

The present invention relates to a structure for mounting a battery pack on a vehicle in which the battery pack, which comprises a battery case that houses a plurality of batteries, a cooling air suction member that sucks cooling air into a cooling passage formed in an interior of the battery case, and a cooling air discharge member that discharges cooling air from the cooling passage, is disposed beneath a floor panel and a cross member that extends in a vehicle width direction.

### BACKGROUND ART

An arrangement in which a groove-shaped recess portion extending in the vehicle width direction is formed on an upper face of a battery case of a battery pack of an electric automobile, and when the battery pack is mounted on a vehicle body from below, a cross member of the vehicle body extending in the vehicle width direction is fitted into the recess portion, is known from Patent Document 1 below.

### RELATED ART DOCUMENTS

### Patent Document

Patent Document 1: Japanese Patent Application Laid-open No. 2009-87773

### SUMMARY OF THE INVENTION

### Problems to Be Solved by the Invention

In the above conventional arrangement, a tunnel part forming a cooling air passage in the interior of the battery case protrudes upwardly so as to intersect the recess portion of the battery case, and in order to avoid interference with this tunnel part, a recessed part (cutout) is formed on a lower face of the cross member fitted into the recess portion, but there is the problem that the strength of the crossmember is degraded by this recessed part. If in order to avoid this the position of the cross member were to be raised, the capacity of a vehicle compartment would be constrained, whereas if the position of the battery pack were to be lowered, there would be the problem that the minimum ground clearance would decrease and it would become easy for the battery to become wet. Furthermore, if the tunnel part were to be moved downward so as not to interfere with the recess portion, it would become necessary to reduce the flow path cross-sectional area of the tunnel part in order to avoid interference with an article housed in the interior of the battery case, and there is a possibility that the battery cooling performance would be degraded.

The present invention has been accomplished in light of the above circumstances, and it is an object thereof to ensure performance in the cooling of a battery by means of a cooling passage in the interior of a battery case while avoiding interference between the battery case and a cross member.

### Means for Solving the Problems

In order to attain the above object, according to a first aspect of the present invention, there is provided a structure for mounting a battery pack on a vehicle in which the battery pack, which comprises a battery case that houses a plurality of batteries, a cooling air suction member that sucks cooling air into a cooling passage formed in an interior of the battery case, and a cooling air discharge member that discharges cooling air from the cooling passage, is disposed beneath a floor panel and a cross member that extends in a vehicle width direction, wherein a recess portion extending in the vehicle width direction is formed on an upper face of the battery case, the cross member being fitted into the recess portion, the cooling air suction member is disposed to the rear of the cross member, a space part is formed between a lower face of the floor panel and an upper face of the battery case in front of the cooling air suction member, and the cooling passage formed beneath the plurality of batteries comprises an upstream side cooling passage that extends from the cooling air suction member forward of the cross member and a downstream side cooling passage that extends from the downstream side of the upstream side cooling passage toward the cooling air discharge member.

Further, according to a second aspect of the present invention, in addition to the first aspect, the cooling air suction member is disposed higher than the cooling passage.

Furthermore, according to a third aspect of the present invention, in addition to the first or second aspect, the battery case comprises a projecting portion that protrudes upwardly within the space part.

Moreover, according to a fourth aspect of the present invention, in addition to any one of the first to third aspects, the cross member is disposed beneath a front seat.

Further, according to a fifth aspect of the present invention, in addition to the third aspect, the projecting portion is disposed beneath a rear seat.

Furthermore, according to a sixth aspect of the present invention, in addition to any one of the first to fifth aspects, the downstream side cooling passage is connected to the upstream side cooling passage in front of the cross member and is connected to the cooling air discharge member to the rear of the cross member.

Moreover, according to a seventh aspect of the present invention, in addition to the sixth aspect, the cooling air suction member and the cooling air discharge member are disposed on a straight line along the vehicle width direction.

Further, according to an eighth aspect of the present invention, in addition to the sixth or seventh aspect, the upstream side cooling passage is disposed in a middle part in the vehicle width direction, and the downstream side cooling passages branch from the upstream side cooling passage and are disposed on opposite parts in the vehicle width direction.

A middle cross member 20 of an embodiment corresponds to the cross member of the present invention, a battery module 42 of the embodiment corresponds to the battery of the present invention, an upstream side cooling passage 45A and a downstream side cooling passage 45B of the embodiment correspond to the cooling passage of the present invention, a suction duct 48 of the embodiment corresponds to the cooling air suction member of the present invention, and a discharge duct 49 of the embodiment corresponds to the cooling air discharge member of the present invention.

### Effects of the Invention

In accordance with the first aspect of the present invention, air in the space part formed between the lower face of the floor panel and the upper face of the battery case is sucked into the interior of the battery case via the cooling air suction member and, while flowing through the upstream side cooling passage extending forward of the cross member and the downstream side cooling passage extending from the downstream side of the upstream side cooling passage toward the cooling air discharge member, can cool the battery disposed thereabove. Since the recess portion, into which the cross member is fitted, is formed on the upper face of the battery case so as to extend in the vehicle width direction, it is possible to mount the battery pack on the vehicle body without interfering with the cross member, and it is unnecessary to raise the position of the cross member or form a cutout in the cross member, thereby enabling a balance to be achieved between the capacity of the vehicle compartment and the strength of the cross member while ensuring a sufficient minimum ground clearance for the battery pack and preventing the battery from becoming wet. Furthermore, since the recess portion is formed on the upper face of the battery case, the cooling passage disposed beneath the battery is not narrowed, thus ensuring the battery cooling performance.

Moreover, in accordance with the second aspect of the present invention, since the cooling air suction member is disposed higher than the cooling passage of the battery case, it is possible to raise the position of the cooling air suction member and make it difficult for water to be sucked into the battery pack.

Furthermore, in accordance with the third aspect of the present invention, since the battery case includes the projecting portion protruding upwardly within the space part for guiding cooling air into the cooling air suction member, it is possible by means of the projecting portion to provide shielding from dust or water scattered from the front together with cooling air, thereby making it difficult for it to be sucked into the battery case via the cooling air suction member.

Moreover, in accordance with the fourth aspect of the present invention, since the cross member is disposed beneath the front seat, even if part of the floor panel becomes high due to the cross member, because the position thereof is beneath the front seat, it is possible to prevent the space around the feet of an occupant seated on the rear seat from being narrowed, thereby improving the comfort of the rear seat.

Furthermore, in accordance with the fifth aspect of the present invention, since the projecting portion is disposed beneath the rear seat, it is possible to avoid constraint of the vehicle compartment space due to provision of the projecting portion.

Moreover, in accordance with the sixth aspect of the present invention, since the downstream side cooling passage is connected to the upstream side cooling passage in front of the cross member and is connected to the cooling air discharge member to the rear of the cross member, it is possible to maximize the length of the upstream side cooling passage and the downstream side cooling passage, thus enhancing the battery cooling performance.

Furthermore, in accordance with the seventh aspect of the present invention, since the cooling air suction member and the cooling air discharge member are disposed on the straight line along the vehicle width direction, it is possible to minimize any increase in the dimension in the fore-and-aft direction of the battery pack due to provision of the cooling air suction member and the cooling air discharge member.

Moreover in accordance with the eighth aspect of the present invention, since the upstream side cooling passage is disposed in the middle part in the vehicle width direction and the downstream side cooling passages branch from the upstream side cooling passage and are disposed on the opposite parts in the vehicle width direction, it is possible to cool the batteries in the middle part in the vehicle width direction, which tend to attain a relatively high temperature, by means of cooling air flowing through the upstream side cooling passage and having a relatively low temperature and cool the batteries in opposite parts in the vehicle width direction, which have a relatively low temperature, by means of cooling air flowing through the downstream side cooling passages and having a relatively high temperature, thereby making the temperature of the all batteries uniform.

### BRIEF DESCRIPTION OF DRAWINGS

FIG. 1 is a side view of an electric automobile. (first embodiment)

FIG. 2 is a perspective view of a vehicle body frame and a battery pack. (first embodiment)

FIG. 3 is a perspective view of the battery pack. (first embodiment)

FIG. 4 is a view in the direction of arrow 4 in FIG. 1. (first embodiment)

FIG. 5 is a sectional view along line 5-5 in FIG. 4. (first embodiment)

FIG. 6 is a sectional view along line 6-6 in FIG. 4. (first embodiment)

FIG. 7 is a sectional view along line 7-7 in FIG. 6. (first embodiment)

FIG. 8 is a sectional view along line 8-8 in FIG. 5. (first embodiment)

### EXPLANATION OF REFERENCE NUMERALS AND SYMBOLS

20 Middle cross member (cross member)
24 Battery case
26 Floor panel
29A Front seat
29B Rear seat
30 Space part
31 Battery pack
39a Projecting portion
39b Recess portion
42 Battery module (battery)
45A Upstream side cooling passage (cooling passage)
45B Downstream side cooling passage (cooling passage)
48 Suction duct (cooling air suction member)
49 Discharge duct (cooling air discharge member)

### MODES FOR CARRYING OUT THE INVENTION

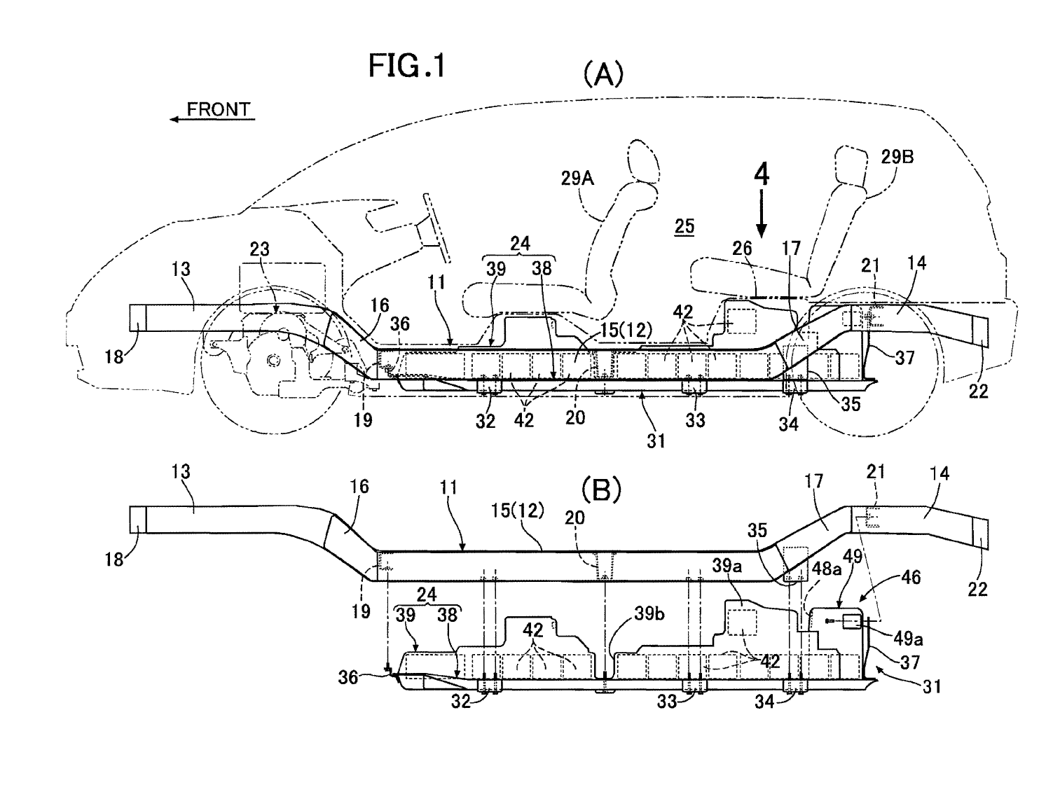

A mode for carrying out the present invention is explained below by reference to FIG. 1 to FIG. 8.

### First Embodiment

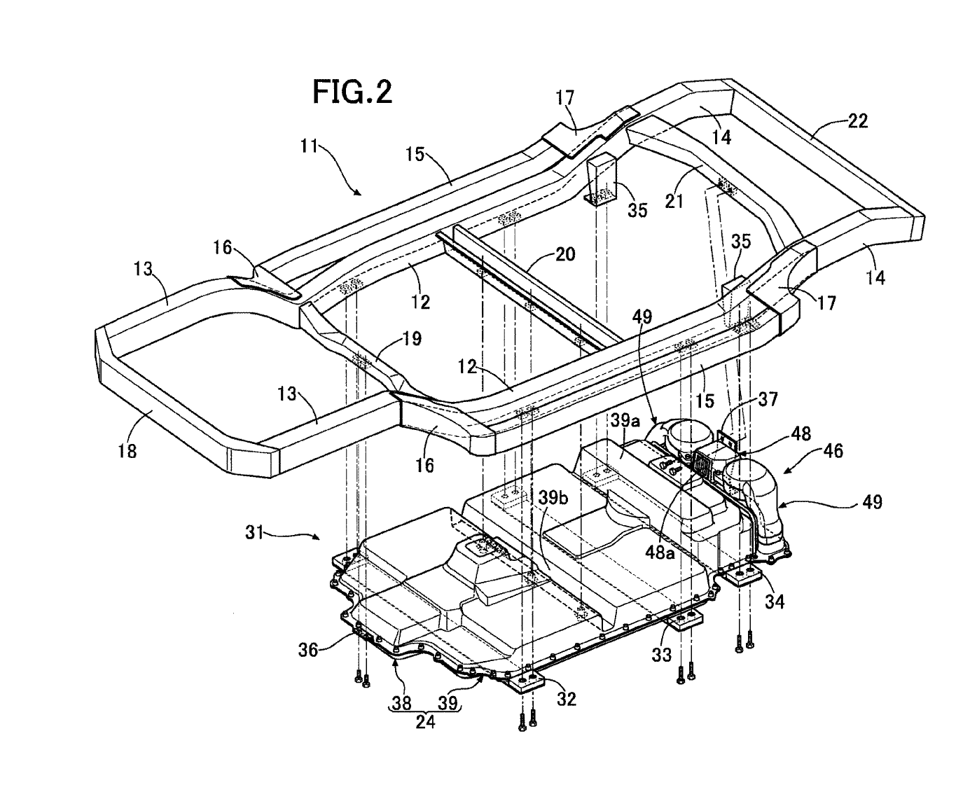

As shown in FIG. 1 and FIG. 2, a vehicle body frame 11 of an electric automobile includes a pair of left and right floor frames 12 and 12 extending in the vehicle body fore-and-aft direction, a pair of left and right front side frames 13 and 13 extending forwardly from the front ends of the floor frames 12 and 12 while bending upwardly, a pair of left and right rear side frames 14 and 14 extending rearwardly from the rear ends of the floor frames 12 and 12 while bending upwardly, a pair of left and right side sills 15 and 15 disposed outside, in the vehicle width direction, of the floor frames 12 and 12, a pair of left and right front outriggers 16 and 16 connecting the front ends of the side sills 15 and 15 to the front ends of the floor frames 12 and 12, a pair of left and right rear outriggers 17 and 17 connecting the rear ends of the side sills 15 and 15 to the rear ends of the floor frames 12 and 12, a front bumper beam 18 providing a connection between front end parts of the pair of left and right front side frames 13 and 13 in the vehicle width direction, a front cross member 19 providing a connection between front end parts of the pair of left and right floor frames 12 and 12 in the vehicle width direction, a middle cross member 20 providing a connection between intermediate parts, in the fore-and-aft direction, of the pair of left and right floor frames 12 and 12 in the vehicle width direction, a rear cross member 21 providing a connection between intermediate parts, in the fore-and-aft direction, of the pair of left and right rear side frames 14 and 14 in the vehicle width direction, and a rear bumper beam 22 providing a connection between rear end parts of the pair of left and right rear side frames 14 and 14 in the vehicle width direction.

A battery pack 31, which is a power source for a motor/generator 23 that is a drive source for making the electric automobile travel, is supported so as to be suspended from a lower face of the vehicle body frame 11. That is, fixed to a lower face of the battery pack 31 are a front suspension beam 32, middle suspension beam 33, and rear suspension beam 34 extending in the vehicle width direction, fixed to front parts of the pair of left and right floor frames 12 and 12 are opposite ends of the front suspension beam 32, fixed to rear parts of the pair of left and right floor frames 12 and 12 are opposite ends of the middle suspension beam 33, and fixed to the lower ends of support members 35 and 35 hanging down from front parts of the pair of left and right rear side frames 14 and 14 are opposite ends of the rear suspension beam 34. Furthermore, a middle part, in the vehicle width direction, of the front end of the battery pack 31 is supported on the front cross member 19 via a front bracket 36, and a middle part, in the vehicle width direction, of the rear end of the battery pack 31 is supported on the rear cross member 21 via a rear bracket 37. Moreover, the battery pack 31 is supported on a lower face of the middle cross member 20 in an intermediate position between the front suspension beam 32 and the middle suspension beam 33.

In a state in which the battery pack 31 is supported on the vehicle body frame 11, an upper face of the battery pack 31 opposes a lower part of a vehicle compartment 25 via a floor panel 26. That is, the battery pack 31 of the present embodiment is disposed outside the vehicle compartment 25.

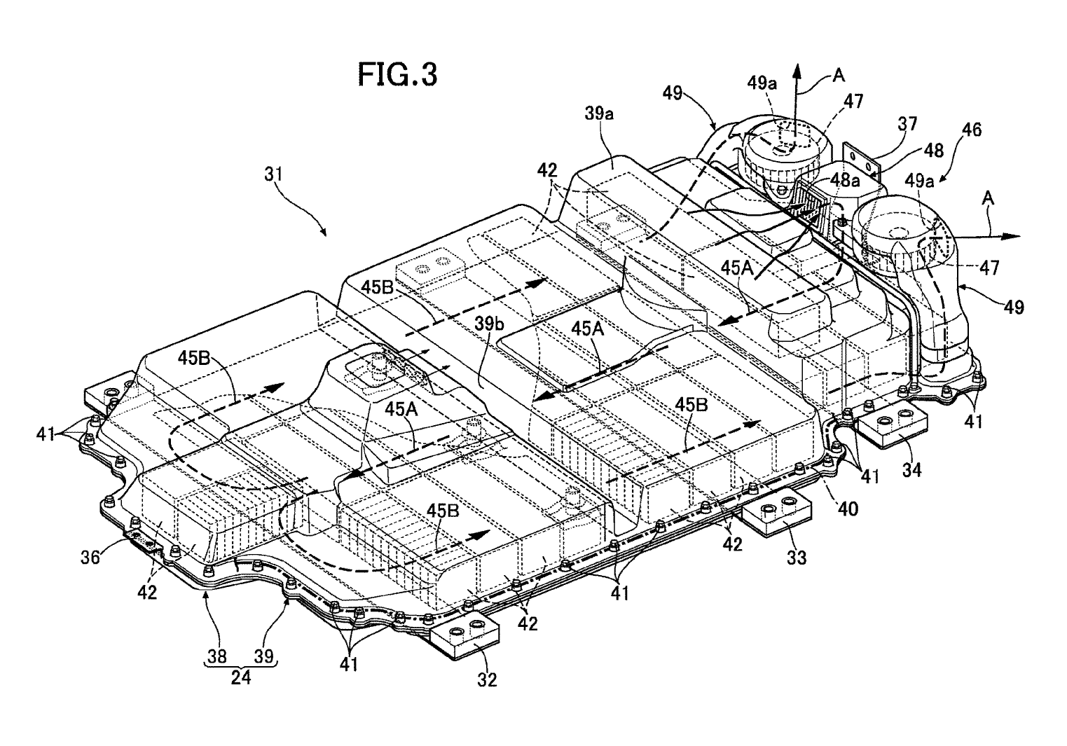

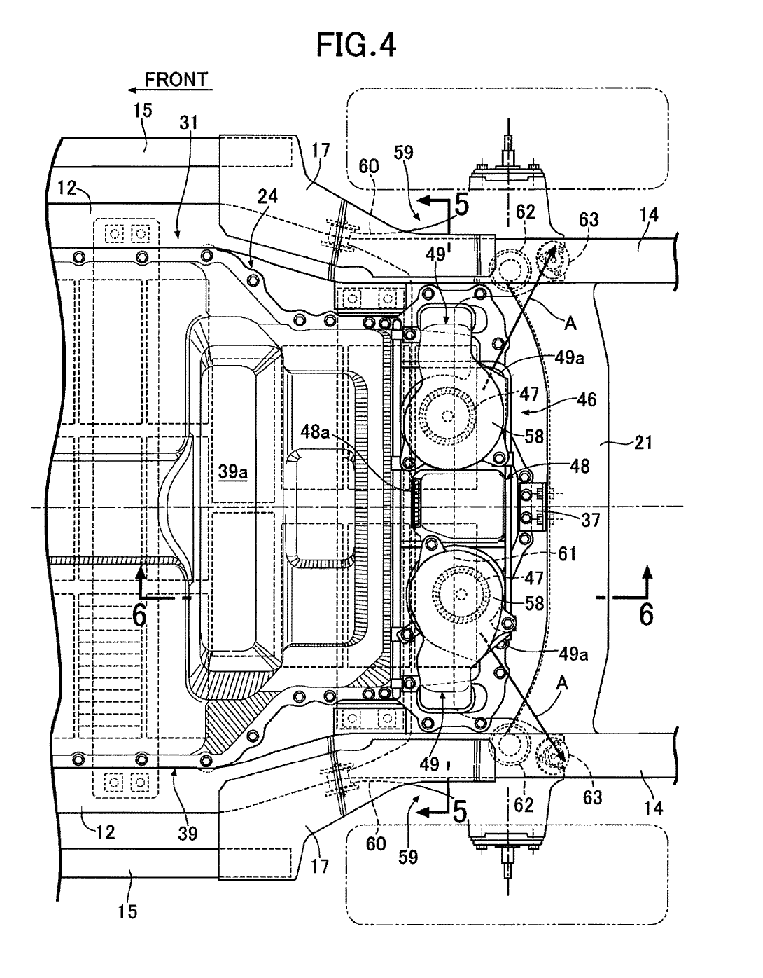

As shown in FIG. 3 and FIG. 4, the battery pack 31 includes a battery tray 38 made of metal and a battery cover 39, made of a synthetic resin, superimposed on the battery tray 38 from above. A peripheral part of the battery tray 38 and a peripheral part of the battery cover 39 are secured by means of a large number of bolts 41 with a seal member 40 (see FIG. 3) sandwiched therebetween, the interior of the battery pack 31 being therefore basically hermetically sealed. A plurality of battery modules 42, in which a plurality of battery cells are stacked in series, are mounted on an upper face of the battery tray 38. The battery tray 38 and the battery cover 39 form a battery case 24 of the present invention.

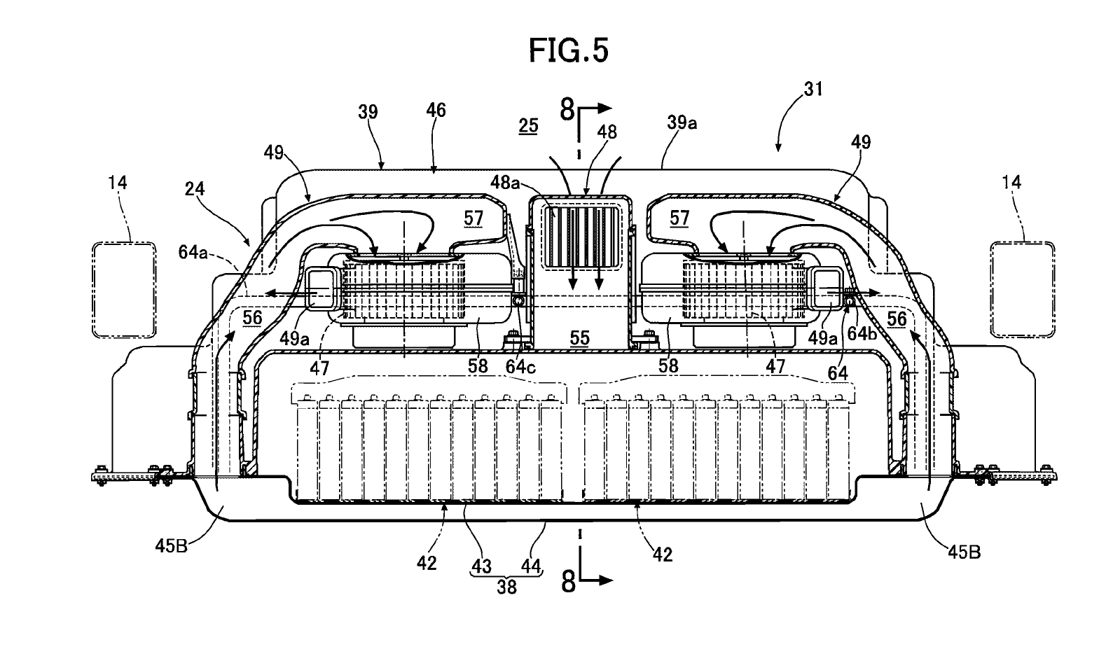

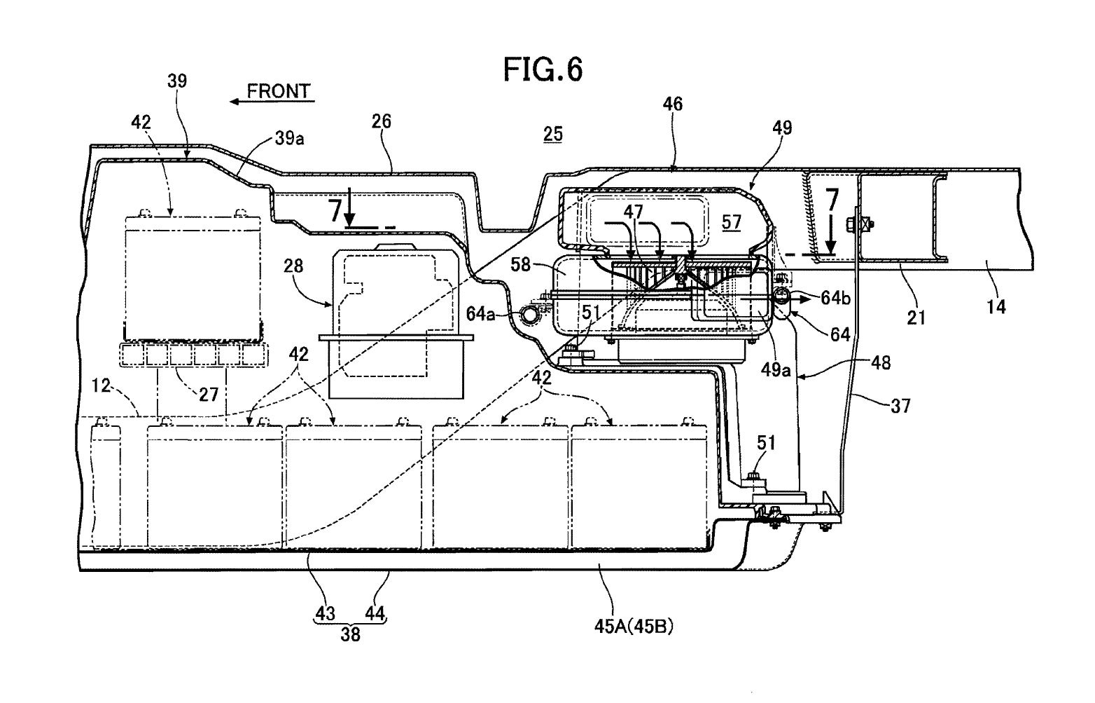

The battery tray 38 is formed by joining an upper plate 43 and a lower plate 44 (see FIG. 5 and FIG. 6), a cooling passage for cooling air to flow being formed therebetween, and heat exchange is carried out with the battery modules 42, which are in contact with an upper face of the upper plate 43, thus cooling the battery modules 42, which generate heat by charging/discharging.

A cooling device 46 provided on a rear part of the battery pack 31 includes a suction duct 48 disposed in a middle part in the vehicle width direction and a pair of left and right discharge ducts 49 and 49 disposed on opposite sides in the vehicle width direction of the suction duct 48. Cooling air sucked in via the suction duct 48 flows from the rear to the front through an upstream side cooling passage 45A (see FIG. 3) disposed in a middle part in the vehicle width direction of the interior of the battery tray 38, then does a U turn, flows from the front to the rear through left and right downstream side cooling passages 45B and 45B (see FIG. 3) disposed on opposite parts in the vehicle width direction of the interior of the battery tray 38, and is then discharged to the outside via the left and right discharge ducts 49 and 49.

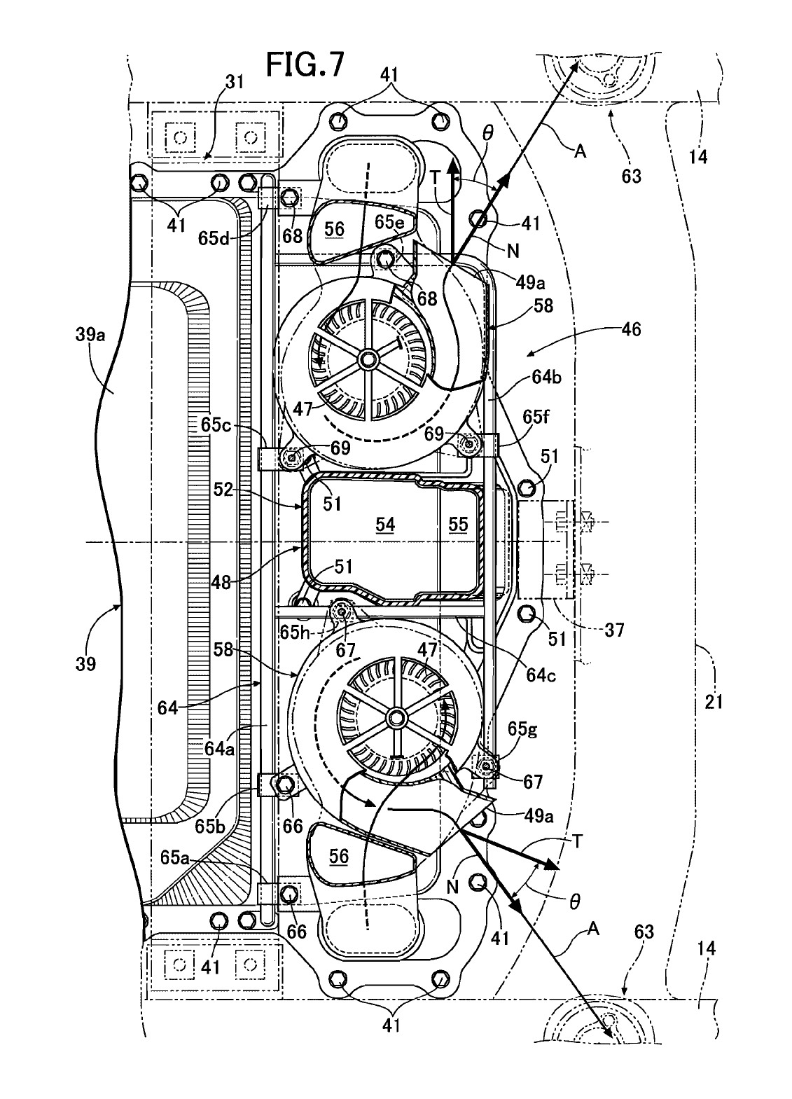

A cooling air suction port 48a opens on a front face of an upper part of the suction duct 48 so as to face forward, the cooling air suction port 48a sucking air outside the battery pack 31 into the interior of the suction duct 48 as cooling air. Electric cooling fans 47 and 47 are housed in the interiors of the respective discharge ducts 49 and 49, and cooling air discharge ports 49a and 49a are formed so as to face the outer peripheries of the respective cooling fans 47 and 47, the cooling air discharge ports 49a and 49a discharging cooling air that has been subjected to heat exchange. The left and right cooling air discharge ports 49a and 49a open rearwardly and outwardly in the vehicle width direction (see arrows A in FIG. 3, FIG. 4, and FIG. 7).

Therefore, when the cooling fans 47 and 47 are driven, cooling air sucked in via the cooling air suction port 48a of the suction duct 48 is supplied to the interior of the battery tray 38, carries out heat exchange with the battery modules 42 while flowing through the upstream side cooling passage 45A and the downstream side cooling passages 45B and 45B in the interior of the battery tray 38, then passes through the cooling fans 47 and 47 of the discharge ducts 49 and 49, and is discharged via the cooling air discharge ports 49a and 49a.

The structure of the cooling device 46 is now explained in detail by reference to FIG. 4 to FIG. 8.

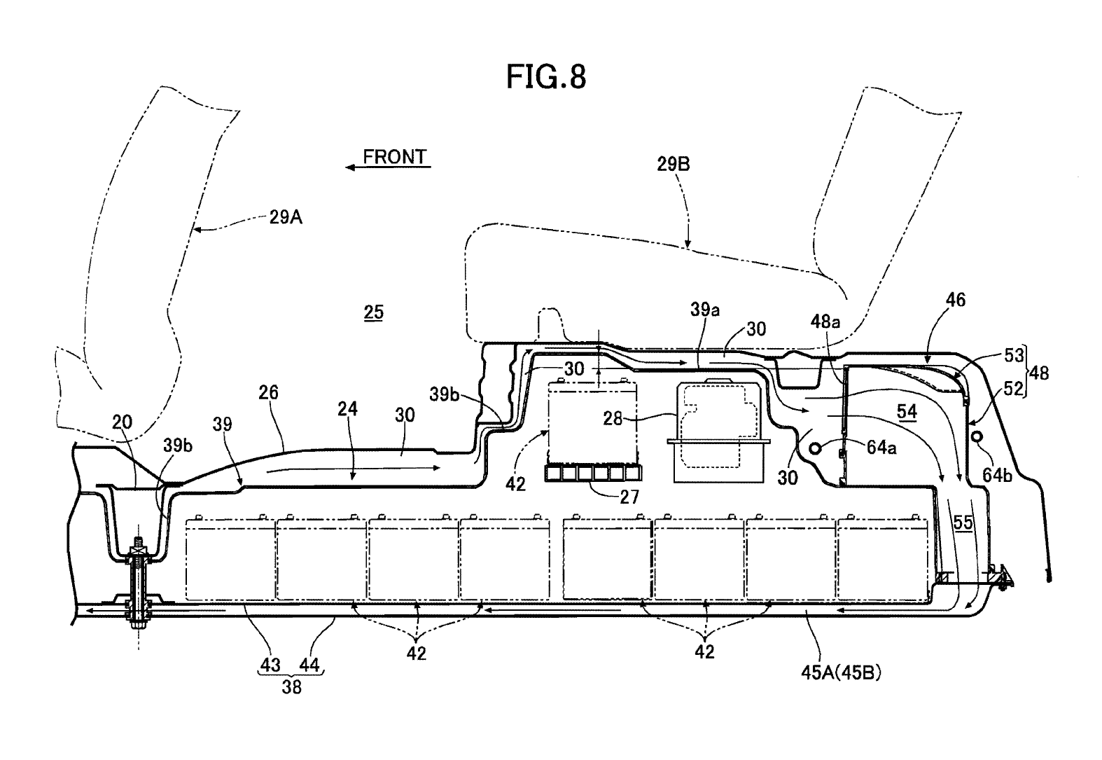

As shown in FIG. 7 and FIG. 8, the suction duct 48 of the cooling device 46 is provided to the rear of a projecting portion 39a protruding upwardly from a rear part of the battery cover 39 (see FIG. 8), and includes a lower member 52 fixed to an upper face of the battery cover 39 by means of four bolts 51 and an upper member 53 joined so as to cover an open part at the upper end of the lower member 52, the cooling air suction port 48a opening on a front face of the upper member 53. With regard to the position of the cooling air suction port 48a, it is positioned above a rear part of the battery pack 31 and is positioned to the rear of the projecting portion 39a of the battery cover 39, and the height of the upper end of the projecting portion 39a is set so as to be higher than the height of the upper end of the cooling air suction port 48a.

The projecting portion 39a of the battery cover 39 is formed so as to be hollow, and two battery modules 42 and 42 are arranged side by side in the vehicle width direction in a front portion thereof at a position that is stepped higher than the other battery modules 42. A battery support member 27 for supporting the two battery modules 42 and 42 is formed so as to be hollow, cooling air flowing through the interior thereof. A rear portion of the projecting portion 39a of the battery cover 39 houses a junction board 28 for supporting an electrical component such as a contactor or a fuse.

A groove-shaped recess portion 39b extending in the vehicle width direction is formed in front of the projecting portion 39a on the upper face of the battery cover 39. In a state in which the battery pack 31 is mounted on the vehicle body frame 11, the middle cross member 20 thereof is fitted into the recess portion 39b of the battery cover 39 from above (see FIG. 8). Formed to the rear of the recess portion 39b of the battery cover 39 is a space part 30 sandwiched between the upper face of the battery cover 39 and a lower face of the floor panel 26, the cooling air suction port 48a of the suction duct 48 opening to the rear of the space part 30.

The interior of the suction duct 48 includes an upstream side suction passage 54 extending rearwardly from the cooling air suction port 48a, and a downstream side suction passage 55 extending downwardly from the rear end of the upstream side suction passage 54 and communicating with the upstream side cooling passage 45A of the battery tray 38. The upstream side suction passage 54 is defined in the interior of the upper member 53, and the downstream side suction passage 55 is defined in the interior of the lower member 52.

As shown in FIG. 4 to FIG. 7, the discharge ducts 49 and 49 of the cooling device 46 include upstream side discharge passages 56 and 56 rising upwardly from the downstream ends of the downstream side cooling passages 45B and 45B of the battery tray 38, and downstream side discharge passages 57 and 57 extending to the inside in the vehicle width direction from the upper ends of the upstream side discharge passages 56 and 56, and the cooling fans 47 and 47 are disposed immediately below the downstream side discharge passages 57 and 57. Spiral-shaped fan casings 58 and 58 surround the outer peripheries of the cooling fans 47 and 47, and the cooling air discharge ports 49a and 49a open at the outer ends of the fan casings 58 and 58.

The fan casings 58 and 58 for the left and right cooling fans 47 and 47 employ interchangeable identical members, and therefore when viewed from above (see FIG. 7) the left and right fan casings 58 and 58 are asymmetric with respect to the vehicle body center line. As described above, the cooling air discharge ports 49a and 49a of the left and right cooling fans 47 and 47 discharge cooling air, as shown by arrows A, rearwardly and outwardly in the vehicle width direction, a normal N perpendicular to the cooling air discharge ports 49a and 49a being inclined relative to a tangent T of the fan casings 58 and 58 only by an angle θ.

Since cooling air flows out at right angles to a plane formed by the cooling air discharge ports 49a and 49a, due to the normal N perpendicular to the cooling air discharge ports 49a and 49a being inclined relative to the tangent T of the fan casings 58 and 58 only by the angle θ it is possible to discharge cooling air from the left and right cooling air discharge ports 49a and 49a in substantially symmetrical directions while reducing the number of types of components by using the interchangeable identical members for the left and right fan casings 58 and 58.

Suspension systems 59 and 59 for the suspension of rear wheels (see FIG. 4) are formed from for example an H-shaped torsion beam type suspension, and include left and right trailing arm parts 60 and 60, a torsion beam part 61 for connecting them in the vehicle width direction, and left and right suspension springs 62 and 62 and left and right suspension dampers 63 and 63 for supporting the rear ends of the trailing arm parts 60 and 60 on lower faces of the rear side frames 14 and 14.

The directions (see arrows A) in which cooling air is discharged from the cooling air discharge ports 49a and 49a of the left and right fan casings 58 and 58 overlap parts of the suspension systems 59 and 59 (the suspension dampers 63 and 63 in the embodiment) when viewed from above. Since the directions A in which cooling air is discharged from the cooling air discharge ports 49a and 49a are set so as to be the directions described above, cooling air can be discharged smoothly outside the vehicle through spaces in the suspension systems 59 and 59 while minimizing interference with the vehicle body.

A support frame 64 supporting the discharge ducts 49 and 49 together with the cooling fans 47 and 47 on the upper face of the rear part of the battery case 24 includes a first frame 64a formed by bending a pipe material into an inverted U-shape and providing opposite ends thereof so as to stand on left and right upper faces of the battery cover 39, an L-shaped second frame 64b connected to the right end side of the first frame 64a and extending rearwardly and leftwardly, and an I-shaped third frame 64c providing a connection, in the fore-and-aft direction, between the left end side of the second frame 64b and an intermediate part of the first frame 64a.

The support frame 64 includes four mounting brackets 65a to 65d fixed to the first frame 64a, three mounting brackets 65e to 65g fixed to the second frame 64b, and one mounting bracket 65h fixed to the third frame 64c (see FIG. 7). The left discharge duct 49 is secured to the two mounting brackets 65a and 65b of the first frame 64a by means of bolts 66 and 66 respectively, and the left discharge duct 49 and the left cooling fan 47 are secured to the mounting bracket 65g of the second frame 64b and the mounting bracket 65h of the third frame 64c by bolts 67 and 67 respectively.

Furthermore, the right discharge duct 49 is secured to the mounting bracket 65d of the first frame 64a and the mounting bracket 65e of the second frame 64b by means of bolts 68 and 68 respectively, and the right discharge duct 49 and the right cooling fan 47 are secured to the mounting bracket 65c of the first frame 64a and the mounting bracket 65f of the second frame 64b by means of bolts 69 and 69 respectively.

In this way, since the discharge ducts 49 and 49 and the cooling fans 47 and 47 are secured to the support frame by the common bolts 67, 67, 69, and 69, it is possible to reduce the size of the cooling device 46 and cut the number of components.

The operation of the embodiment of the present invention having the above arrangement is now explained.

Since the battery modules 42 housed within the battery case 24 of the battery pack 31 generate heat due to charging/discharging, they are cooled with cooling air supplied to the interior of the battery tray 38 by means of the cooling device 46. That is, when the cooling fans 47 and 47 are driven, air between the upper face of the battery case 24 and the lower face of the floor panel 26 is sucked in as cooling air via the cooling air suction port 48a of the suction duct 48 and supplied to the interior of the battery tray 38 via the upstream side suction passage 54 and downstream side suction passage 55 of the suction duct 48.

As shown in FIG. 3, cooling air supplied to the interior of the battery tray 38 carries out heat exchange between the upper plate 43 of the battery tray 38 and the bottom faces of the battery modules 42 while flowing through the upstream side cooling passage 45A and the downstream side cooling passages 45B and 45B in the interior of the battery tray 38, thus cooling the battery modules 42. Cooling air that has flowed from the downstream side cooling passages 45B and 45B into the discharge ducts 49 and 49 passes through the upstream side discharge passages 56 and 56, the downstream side discharge passages 57 and 57, and the cooling fans 47 and 47, and is discharged via the cooling air discharge ports 49a and 49a of the fan casings 58 and 58.

Since the recess portion 39b extending in the vehicle width direction is formed on the upper face of the battery cover 39 of the battery case 24, and the middle cross member 20 is fitted into the recess portion 39b from above, not only is it possible to mount on the vehicle body frame 11 the battery pack 31 without interfering with the middle cross member 20, but it is also possible, due to it being unnecessary to raise the position of the middle cross member 20 or form a cutout in the middle cross member 20, to achieve a balance between the capacity for the vehicle compartment 25 and the strength of the middle cross member 20 while ensuring a sufficient minimum ground clearance for the battery pack 31 to thus prevent the battery modules 42 from becoming wet. Furthermore, since the recess portion 39b is formed on the upper face of the battery cover 39, the upstream side cooling passage 45A and the downstream side cooling passages 45B and 45B disposed in the lower part of the battery case 24 are not narrowed by the recess portion 39b, and performance in the cooling of the battery modules 42 by means of the upstream side cooling passage 45A and the downstream side cooling passages 45B and 45B is ensured.

Moreover, since the middle cross member 20 is disposed beneath the front seat 29A (see FIG. 8), even if the height of the floor panel 26 above the middle cross member 20 increases slightly, because that portion is contained in a space beneath the front seat 29A, it is possible to prevent the space around the feet of an occupant seated on the rear seat 29B from being constrained by the middle cross member 20.

Furthermore, since the battery pack 31 is mounted beneath the vehicle compartment 25, and the suction duct 48 and the discharge ducts 49 and 49 are disposed at positions sandwiched between the battery case 24 and the vehicle compartment 25, the cooling air suction port 48a of the suction duct 48 and the cooling air discharge ports 49a and 49a of the discharge ducts 49 and 49 are formed at relatively high positions of the battery pack 31, and the cooling air suction port 48a and the cooling air discharge ports 49a and 49a are covered from above and from below by the floor panel 26 and the battery case 24, thereby making it difficult for dust or water dropping from above or dust or water thrown up from a road surface or a wheel to enter via the cooling air suction port 48a or the cooling air discharge ports 49a and 49a.

Furthermore, since the suction duct 48 is disposed in the upper part at the rear end of the battery cover 39, the projecting portion 39a is provided on the battery cover 39 so as to protrude upwardly toward the vehicle compartment 25, and the suction duct 48 is disposed to the rear of the projecting portion 39a of the battery cover 39, the projecting portion 39a of the battery cover 39 can provide shielding from dust or water, which is scattered from the front of the vehicle body while the vehicle is traveling, thus making it difficult for dust or water to be sucked into the interior of the battery cover 39 via the cooling air suction port 48a. In this arrangement, since the height of the upper end of the projecting portion 39a is at a position higher than the height of the upper end of the cooling air suction port 48a, it is possible to enhance the effect in trapping dust or water by reliably shielding the cooling air by means of the projecting portion 39a.

Furthermore, since the space part 30 for introducing cooling air into the cooling air suction port 48a is formed between the floor panel 26 and the battery case 24, cooling air is put into contact with both the floor panel 26 and the battery case 24 until reaching the cooling air suction port 48a, thus enabling dirt or water contained in the cooling air to be removed more effectively.

Moreover, since the projecting portion 39a of the battery case 24 is disposed beneath the rear seat 29B, it is possible to avoid constraint of the vehicle compartment space due to provision of the projecting portion 39a.

Furthermore, since the downstream side cooling passages 45B and 45B are connected to the upstream side cooling passage 45A in front of the cross member 20 and are connected to the discharge duct 49 to the rear of the cross member 20, it is possible to maximize the length of the upstream side cooling passage 45A and the downstream side cooling passages 45B and 45B, thus enhancing the battery cooling performance.

Moreover, since the suction duct 48 and the discharge duct 49 are disposed on the straight line along the vehicle width direction, it is possible to minimize any increase in dimension in the fore-and-aft direction of the battery pack 31 due to provision of the suction duct 48 and the discharge duct 49.

Furthermore, since the upstream side cooling passage 45A is disposed in the middle part in the vehicle width direction and the downstream side cooling passages 45B and 45B branch from the upstream side cooling passage 45A and are disposed on the opposite parts in the vehicle width direction, it is possible to cool the battery modules 42 in the middle part in the vehicle width direction, which tend to attain a relatively high temperature, by means of cooling air flowing through the upstream side cooling passage 45A and having a relatively low temperature and cool the battery modules 42 on the opposite parts in the vehicle width direction, which tend to have a relatively low temperature, by means of cooling air flowing through the downstream side cooling passages 45B and 45B and having a relatively high temperature, thereby making the temperature of the all battery modules 42 uniform.

An embodiment of the present invention is explained above, but the present invention may be modified in a variety of ways as long as the modifications do not depart from the spirit and scope thereof.

For example, the arrangement of the upstream side cooling passage 45A and the downstream side cooling passages 45B and 45B within the battery tray 38 is not limited to that shown in FIG. 3 as long as the upstream side cooling passage 45A extends forwardly from the suction duct 48 and the downstream side cooling passages 45B and 45B extend rearwardly to thus communicate with the discharge ducts 49 and 49.

Furthermore, the space part 30 is not limited to one extending in the vehicle body fore-and-aft direction and may be one that extends in the vehicle width direction and communicates with the outside of the vehicle.

1. A structure for mounting a battery pack on a vehicle in which the battery pack, which comprises a battery case that houses a plurality of batteries, a cooling air suction member that sucks cooling air into a cooling passage formed in an interior of the battery case, and a cooling air discharge member that discharges cooling air from the cooling passage, is disposed beneath a floor panel and a cross member that extends in a vehicle width direction, wherein
a recess portion extending in the vehicle width direction is formed on an upper face of the battery case, the cross member being fitted into the recess portion, the cooling air suction member is disposed to the rear of the cross member, a space part is formed between a lower face of the floor panel and an upper face of the battery case in front of the cooling air suction member, and the cooling passage formed beneath the plurality of batteries comprises an upstream side cooling passage that extends from the cooling air suction member forward of the cross member and a downstream side cooling passage that extends from the downstream side of the upstream side cooling passage toward the cooling air discharge member.

2. The structure for mounting a battery pack on a vehicle according to claim 1, wherein the cooling air suction member is disposed higher than the cooling passage.

3. The structure for mounting a battery pack on a vehicle according to claim 1, wherein the battery case comprises a projecting portion that protrudes upwardly within the space part.

4. The structure for mounting a battery pack on a vehicle according to claim 1, wherein the cross member is disposed beneath a front seat.

5. The structure for mounting a battery pack on a vehicle according to claim 3, wherein the projecting portion is disposed beneath a rear seat.

6. The structure for mounting a battery pack on a vehicle according to claim 1, wherein the downstream side cooling passage is connected to the upstream side cooling passage in front of the cross member and is connected to the cooling air discharge member to the rear of the cross member.

7. The structure for mounting a battery pack on a vehicle according to claim 6, wherein the cooling air suction member and the cooling air discharge member are disposed on a straight line along the vehicle width direction.

8. The structure for mounting a battery pack on a vehicle according to claim 6, wherein the upstream side cooling passage is disposed in a middle part in the vehicle width direction, and the downstream side cooling passages branch from the upstream side cooling passage and are disposed on opposite parts in the vehicle width direction.

9. The structure for mounting a battery pack on a vehicle according to claim 3, wherein the cross member is disposed beneath a front seat.

10. The structure for mounting a battery pack on a vehicle according to claim 9, wherein the downstream side cooling passage is connected to the upstream side cooling passage in front of the cross member and is connected to the cooling air discharge member to the rear of the cross member.

11. The structure for mounting a battery pack on a vehicle according to claim 10, wherein the cooling air suction member and the cooling air discharge member are disposed on a straight line along the vehicle width direction.

12. The structure for mounting a battery pack on a vehicle according to claim 11, wherein the upstream side cooling passage is disposed in a middle part in the vehicle width direction, and the downstream side cooling passages branch from the upstream side cooling passage and are disposed on opposite parts in the vehicle width direction.

13. The structure for mounting a battery pack on a vehicle according to claim 3, wherein the downstream side cooling passage is connected to the upstream side cooling passage in front of the cross member and is connected to the cooling air discharge member to the rear of the cross member.

14. The structure for mounting a battery pack on a vehicle according to claim 13, wherein the cooling air suction member and the cooling air discharge member are disposed on a straight line along the vehicle width direction.

15. The structure for mounting a battery pack on a vehicle according to claim 14, wherein the upstream side cooling passage is disposed in a middle part in the vehicle width direction, and the downstream side cooling passages branch from the upstream side cooling passage and are disposed on opposite parts in the vehicle width direction.

16. The structure for mounting a battery pack on a vehicle according to claim 4, wherein the downstream side cooling passage is connected to the upstream side cooling passage in front of the cross member and is connected to the cooling air discharge member to the rear of the cross member.

17. The structure for mounting a battery pack on a vehicle according to claim 16, wherein the cooling air suction member and the cooling air discharge member are disposed on a straight line along the vehicle width direction.

18. The structure for mounting a battery pack on a vehicle according to claim 5, wherein the downstream side cooling passage is connected to the upstream side cooling passage in front of the cross member and is connected to the cooling air discharge member to the rear of the cross member.

19. The structure for mounting a battery pack on a vehicle according to claim 18, wherein the cooling air suction member and the cooling air discharge member are disposed on a straight line along the vehicle width direction.

20. The structure for mounting a battery pack on a vehicle according to claim 7, wherein the upstream side cooling passage is disposed in a middle part in the vehicle width direction, and the downstream side cooling passages branch from the upstream side cooling passage and are disposed on opposite parts in the vehicle width direction.
